(19) United States
(12) Patent Application Publication
(10) Pub. No.: US 2005/0138417 A1
(43) Pub. Date: Jun. 23, 2005

(54) Trusted network access control system and method

(76) Inventors: Shaun Charles McNerney, Colorado Springs, CO (US); Myron Dean Berg, Colorado Springs, CO (US); Rex Andrew Nelson II, Black Forest, CO (US)

Correspondence Address: Law Office of Dale B. Halling, LLC, Suite 311, 24 S. Weber St., Colorado Springs, CO, 80903, US

(21) Appl. No.: 10/741,138

(22) Filed: Dec. 19, 2003

(51) Int. Cl. G06F 11/30

(52) U.S. Cl. 713/201

(57) ABSTRACT

A trusted network access control system has a remote computing platform running an advisor. A first trusted network access control device is coupled to the remote computer by a network. A director is coupled to the first trusted network access control device and controls the first trusted network access control device.

### FIELD OF THE INVENTION

The present invention relates generally to the field of computer networks and more particularly to a trusted network access control system and method.

### BACKGROUND OF THE INVENTION

As the internet and communication tools have become more common, more employees are working at home or otherwise require access from a remote location to their company's protected computer network. Virtual Private Network (VPN) servers and other remote access controllers are used to limit access to the company's protected network to legitimate uses. However, these remote access controllers do not ensure that the remote user and remote systems are complying with the company's corporate standards and security policies. It is not uncommon for these remote computers to be either personal computers or to have mixed business and personal use. Under these circumstances it is common for these remote computers to have viruses, worms, spyware or other potentially damaging agents. These remote computers can then introduce these harmful agents to the company network.

Thus there exists a need for a system and method that allows only trusted remote computers access to protected networks and prevents untrusted remote computers from accessing and introducing harmful agents into the protected network.

### SUMMARY OF THE INVENTION

A trusted network access control system that overcomes these problems includes a remote computer running an advisor. A first trusted network access control device is coupled to the remote computer by a network. A director is coupled to the first trusted network access control device and controls the first trusted network access control device. In one embodiment, a remote access controller is coupled to the first trusted network access control device. A second trusted network access control device is coupled to the remote access controller. In another embodiment, a protected network is coupled to the first trusted network access control device.

In one embodiment, a protected network is coupled to the second trusted network access control device. In one aspect of the invention, the director controls the second trusted network access control device.

In one embodiment, the advisor sends a trusted state information packet to the director. The director evaluates the trusted state information packet and sends a network access control information packet to the first trusted network access control device.

In another embodiment, the first network access control device is a router.

In one embodiment, a method of trusted network access control includes the steps of sending a trusted state information packet from a remote computer through a network to a director. The level of access allowed the remote computer is determined at the director using the trusted state information packet. An access control information packet is transmitted from the director to a trusted network access control device. In one embodiment when the remote computer is allowed access by the director, the remote computer communicates with a device on a protected network.

In another embodiment, when the remote computer is allowed access by the director, a remote access control information packet is sent from the remote computer to a remote access controller. When the remote computer is allowed access by the remote access controller, a second trusted state information packet is sent to a second director.

In one embodiment, an access control information packet is transmitted from the second director to a second trusted network access control device including a remote computer identifier. In one embodiment, a location identifier is transmitted. In another embodiment, a level of trustworthiness is determined.

In one embodiment, a method of trusted network access control, includes the steps of requesting access to a protected network by a remote computer. A trustworthiness of the remote computer is determined by a network access controller. A level of access to the protected network by the remote computer is provided. In one embodiment, access to the protected network is denied to the remote computer. In another embodiment, access to a part of the protected network is allowed to the remote computer. In another embodiment, access to all of the protected network by the remote computer is allowed.

In one embodiment, a plurality of trust policies are determined. A trust state of the remote computer is evaluated against the plurality of trust policies. In one embodiment, when the trust state fails one of the plurality of trust policies, the level of access is set to no access.

### BRIEF DESCRIPTION OF THE DRAWINGS

FIG. 1 is a block diagram of a trusted network access control system in accordance with one embodiment of the invention;

FIG. 2 is a block diagram of a trusted network access control system in accordance with one embodiment of the invention;

FIG. 3 is a flow chart of the steps used in a method of trusted network access control in accordance with one embodiment of the invention; and

FIG. 4 is a flow chart of the steps used in a method of trusted network access control in accordance with one embodiment of the invention.

### DETAILED DESCRIPTION OF THE DRAWINGS

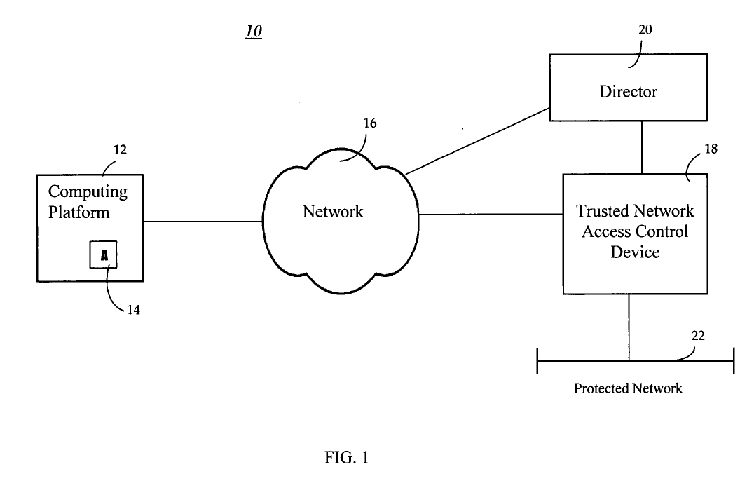

FIG. 1 is a block diagram of a trusted network access control system 10 in accordance with one embodiment of the invention. The system 10 has a remote computer 12 running an advisor 14. The remote computer 12 is coupled through a network 16 to a trusted network access control (TNAC) device 18. The network 16 may be the internet, an intranet, public switched telephone network, other data communication network or a combination of these networks. The trusted network access control device 18 is coupled to a director 20 and to a protected network 22. The trusted network access control device 18 may be a router, firewall, switch, bridge or other network device that is controllable. The director 20 may be a computer that runs director software. In one embodiment, the director and the trusted network access control device are combined to form a network access controller. Note that while a single remote computer 12 is shown, the system is designed for one or many remote computers connecting to the trusted network.

When the remote computer 12 wants to access the protected network 22, which may be a company's internal network, the advisor 14 determines a trust state of the remote computer 12. The computer 12 then sends a trusted state information packet to the director 20. The director 20 evaluates the trusted state information and determines a level of access. The level of access information is forwarded to trusted network access control device 18. There are three broad categories for the level of access: 1) no-access; 2) complete access; and 3) limited access. When the level of access is no-access, the trusted network access control device 18 prevents the remote computer 12 from accessing the protected network 22. The trusted network access control device 18 does this by refusing to accept or forward any data from the remote computer 12 to any device on the protected network 22. When the level of access is complete access, the remote computer 12 may communicate with any device on the protected network 22. When the level of access is limited access, the remote computer 12 is only allowed to communicate with selected devices on the protected network 22. This is accomplished by reviewing the destination address for any data sent from the remote computer 12.

The required trusted state information is determined by the trust policies that are stored in the director 20. If the advisor 14 attempts to log-in with outdated trust policies it is denied access and the advisor14 updates its trust policies from the director 20. Then the remote computer 12 requests access again using the new trust policies to formulate the trusted state information. The trust policies are set by the company or system administrator and may include determining: 1) is anitvirus software installed and running? 2) is file sharing enabled? 3) is the operating system the most recent version including patches? 4) is the personal firewall software running? 5) is any spyware installed or running? 6) is the computer using a wireless network? 7) is the wireless encryption protocol enabled? 8) is the computer connected to a public network? 9) is a password protected screen saver enabled? 10) is the computer being actively used? The director 20 may evaluate the trusted state information and require perfect compliance or it may score the information and compare it to a threshold. The score may determine whether the access is complete or limited. In addition, the remote computer 12 may be any computing platform, such as a PDA, cell phone, personal computer, etc. In one embodiment, the remote computer 12 must send its trust information periodically, for instance every five minutes. If the remote computer does not send its trust state information periodically or the new trust state information fails to establish the proper trust level the connection to the remote computer 12 is terminated.

In one embodiment the advisor 14 also includes a unique digital signature, which may be encrypted, of the remote computer 12 that is authenticated by the director 20. This allows the director 20 to authenticate the remote computer 12 independent of the user of the remote computer 12.

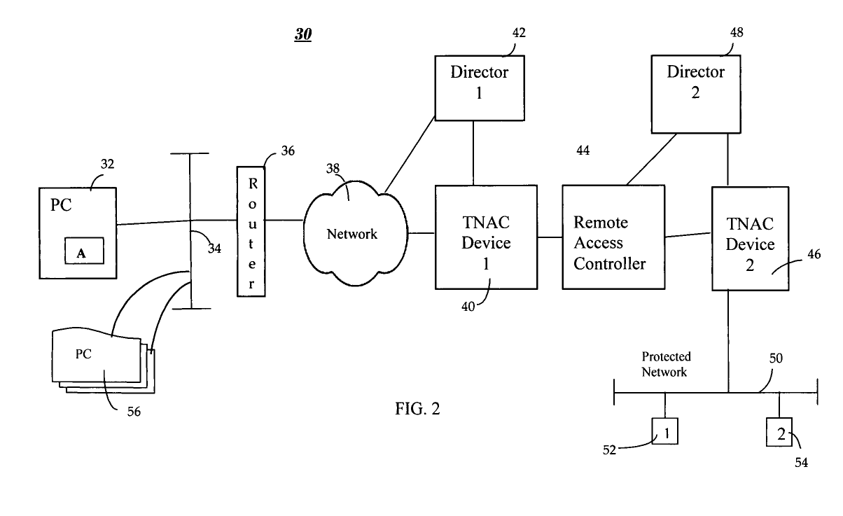

FIG. 2 is a block diagram of a trusted network access control system 30 in accordance with one embodiment of the invention. In this embodiment of the invention the remote computer 32 may be connected to a network 34 and then a router 36. The router 36 is coupled through a network 38 to a first trusted network access control device 40. A first director 42 is coupled to the first trusted network access control device 40. The trusted network access control device 40 is also coupled to a remote access controller 44. An example of a remote access controller 44 is a Virtual Private Network (VPN) server. The remote access controller 44 is coupled to a second trusted network access control device 46. A second director 48 is coupled to the second trusted network access control device 46. A protected network 50 is coupled to the second trusted network access control device 46. A couple of devices 52, 54 may be attached to the network 50.

Note that the remote computer 32 is on a network 34 with a plurality of other computers 56. When the remote computer 32 requests access from the first trusted network access control device 40, the first director 42 may be limited in its ability to differentiate between the remote computer 32 and the plurality of other computers 56 on the same network 34. Once the remote computer 32 is allowed access by the first director 42, it is required to log onto the remote access controller 44. The remote access controller 44 authenticates the user and assigns a remote computer identifier. For instance, it may establish a VPN connection and may assign the remote computer 32 a unique VPN endpoint network address or remote computer identifier. The remote computer 32 then requests access from the second director 48. This allows the second director 48 to uniquely identify the remote computer 32 from the other computers 56 and ensure that none of the other computers 56 are attempting to access the protected network 50 without permission. In one embodiment, the first director 42 and the second director may be one and the same. The trust policies may be the same or different. In some embodiments, the first trusted network access control device 40 may be combined with the remote access controller 44 or the second trusted network access control device 46 may be combined with the remote access controller 44. In one embodiment both the first and second trusted network access control devices 40, 46 and the remote access controller 44 are the same device.

The remote computer 32 may be allowed limited access to the protected network 50. For instance, the remote computer 32 may be allowed to communicate with device-1 52 but not with device-2 54.

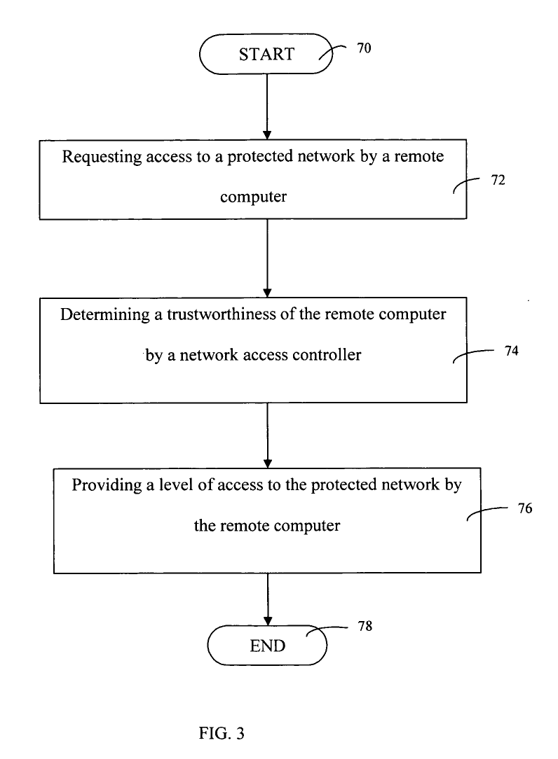

FIG. 3 is a flow chart of the steps used in a method of trusted network access control in accordance with one embodiment of the invention. The process starts, step 70, by requesting access to a protected network by a remote computer at step 72. Next, a trustworthiness of the remote computer is determined by a network access controller at step 74. At step 76 a level of access to the protected network by the remote computer is allowed which ends the process at step 78.

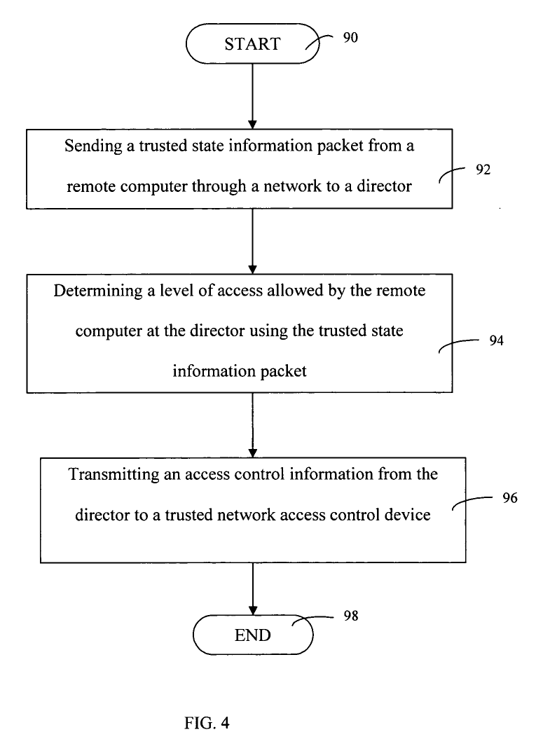

FIG. 4 is a flow chart of the steps used in a method of trusted network access control in accordance with one embodiment of the invention. The process starts, step 90, by sending a trusted state information packet from a remote computer through a network to a director 92. The director determines a level of access allowed by the remote computer using the trusted state information packet at step 94. At step 96 an access control information packet is transmitted from the director to a trusted network access control device which ends the process at step 98.

Thus there has been described a system and method for trusted network access control which allows only trusted remote computing platforms access to protected networks and prevents untrusted remote computing platforms from accessing and introducing harmful agents into protected networks.

The methods described herein can be implemented as computer-readable instructions stored on a computer-readable storage medium that when executed by a computer will perform the methods described herein.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

1. A trusted network access control system, comprising:
a remote computing platform running an advisor;
a first trusted network access control device coupled to the remote computing platform by a network; and
a director coupled to the first trusted network access control device controlling the first trusted network access control device.

2. The system of claim 1, further including:
a remote access controller coupled to the first trusted network access control device;
a second trusted network access control device coupled to the remote access controller.

3. The system of claim 1, further including a protected network coupled to the first trusted network access control device.

4. The system of claim 2, further including a protected network coupled to the second trusted network access control device.

5. The system of claim 2, wherein the director controls the second trusted network access control device.

6. The system of claim 1, wherein the advisor sends a trusted state information packet to the director.

7. The system of claim 6, wherein the director evaluates the trusted state information packet and sends a network access control information packet to the first trusted network access control device.

8. The system of claim 1, wherein the first network access control device is a router.

9. A method of trusted network access control, comprising the steps of:
a) sending a trusted state information packet from a remote computing platform through a network to a director;
b) determining a level of access allowed by the remote computing platform at the director using the trusted state information packet; and
c) transmitting an access control information from the director to a trusted network access control device.

10. The method of claim 9, further including the step of:
d) when the remote computing platform is allowed access by the director, communicating between the remote computing platform and a device on a protected network.

11. The method of claim 9, further including the steps of:
d) when the remote computing platform is allowed access by the director, sending a remote access control information from the remote computer to a remote access controller;
e) when the remote computing platform is allowed access by the remote access controller, sending a second trusted state information packet to a second director.

12. The method of claim 11, further including the steps of:
f) transmitting an access control information from the second director to a second trusted network access control device including a remote computer identifier.

13. The method of claim 9, wherein step (c) further includes the step of:
c1) transmitting a location identifier.

14. The method of claim 9, wherein step (b) further includes the step of:
b) determining a level of trustworthiness.

15. A method of trusted network access control, comprising the steps of:
a) requesting access to a protected network by a remote computer;
b) determining a trustworthiness of the remote computer by a network access controller; and
c) providing a level of access to the protected network by the remote computer.

16. The method of claim 15, wherein step (c) further includes the step of:
c1) denying access to the protected network by the remote computer.

17. The method of claim 15, wherein step (c) further includes the step of:
c1) allowing access to a part of the protected network by the remote computer.

18. The method of claim 15, wherein step (c) further includes the step of:
c1) allowing access to all of the protected network by the remote computer.

19. The method of claim 15, wherein step (b) further includes the steps of:
b1) determining a plurality of trust policies;
b2) evaluating by comparing a trust state of the remote computer to the plurality of trust policies.

20. The method of claim 19, further including the step of:
b3) when the trust state fails one of the plurality of trust policies, setting the level of access to no access.
